(19) United States
(12) Patent Application Publication
(10) Pub. No.: US 2012/0327216 A1
(43) Pub. Date: Dec. 27, 2012

(54) Machine Tool System, especially for Hand-Held Machine Tools

(75) Inventors: Thilo Koeder, Penang (MY); Joachim Platzer, Remseck-Hochberg (DE); Ulli Hoffmann, Niefern-Oeschellbronn (DE)

(73) Assignee: Robert Bosch GmbH, Stuttgart (DE)

(21) Appl. No.: 13/516,474

(22) PCT Filed: Oct. 26, 2010
(86) PCT No.: PCT/EP2010/066150

§ 371 Date: Aug. 29, 2012

(30) Foreign Application Priority Data
Dec. 18, 2009 (DE) 102009054977.3

(51) Int. Cl. H04N 7/18

(52) U.S. Cl. 348/95; 348/E07.085

(57) ABSTRACT

A machine tool system is provided with a detection device for a working line specified for the surface of a workpiece, the marking contour of the working line being viewed from different wavelength ranges.

The invention relates to a machine tool system, especially for hand-held machine tools, according to the precharacterizing clause of claim 1.

### PRIOR ART

Machine tool systems of this type are known in a specific embodiment as jigsaws from DE 10 2006 052 808 A1. They are formed so that a marking contour provided on the surface of the workpiece can be detected, as a working line to be followed by the working tool of the machine tool, by means of a detection device provided on the machine. This is carried out by means of a sensor unit of the detection device whose signals, processed by means of a computation unit, are converted into control instructions for a control device by means of which the working tool, the saw blade in the case of the jigsaw, is aligned with the working line and/or guided along the working line in its working plane by rotation about its stroke axis.

A prerequisite for such semiautonomous working operation is straightforward detection of the working line by means of the sensor unit in the working region of the saw blade on the workpiece. This entails difficulties particularly in the case of marking contours which are blurred in contour from the background on the workpiece and/or have only a low contrast from the background on the workpiece.

### DISCLOSURE OF THE INVENTION

It is an object of the invention to clearly detect a respective marking contour even under difficult conditions of this type, such as occur particularly with unevenly patterned surfaces, and therefore to allow reliable processing along a working line which under certain circumstances may be difficult to detect.

According to the invention, this is achieved by the features of claim 1; the dependent claims indicate expedient refinements.

The starting point for the inventive configuration of a machine tool system with a view to the possibility of an operating mode at least substantially independent of machine tool guidance by the user, i.e. an autonomous or semiautonomous operating mode, is the basic concept of distinguishing between the marking and the workpiece surface in terms of materials, their structure and/or their coloration with regard to reflectivity, so that the marking contour is clearly recognizable in a detection region whose size is defined by the sensor unit, i.e. a very narrow detection region, under observation in different wavelength ranges.

Observation of the marking, or its contour, in different wavelength ranges may in principle be achieved by using separate light sources emitting light of different wavelengths, in which case with a view to detecting the contour along the profile of the marking line, it is preferable to use light sources at small distances from one another which permit correspondingly sharp concentration of the respective light beam.

A preferred and particularly simple solution for observation of the marking contour in different wavelength ranges consists in observing the marking contour by means of the sensor unit through a filter which has separate filter regions for different wavelength ranges.

Such a solution can be achieved, in a particularly simple as well as structurally very compact design, particularly by observing the marking contour at mutually adjacent points by means of a line sensor, in particular a line sensor in the form of a camera, having strip-shaped filters placed in front on the marking side.

As a strip filter, the filter is alternately provided with strip-shaped filter regions which transmit different wavelength ranges. In particular, they extend mutually parallel as well as parallel to the standard search lines of the sensor unit, which is preferably formed by a line sensor. Such a solution, with strip filters placed in front of the line sensor, provides observation of the marking contour with observation points lying at a very small distance from one another in the longitudinal direction of the marking when, of the available lines of the line sensor, the search line adjacent to a respective standard search line is used for the observation in a different wavelength range.

It is, however, also within the scope of the invention respectively to assign a strip region of the strip filter to one of the mutually adjacent standard search lines of the line sensor, so that larger sections are available for the contrast comparison along the marking line.

In the scope of the invention, the strip filter alternately comprises successive filter strips with different coating, or coated and uncoated filter strips.

Considered overall, it is expedient for the marking contour to be observed using a filter having at least two, but in particular more than two wavelength ranges, and for the lines on which there are the greatest contrast differences of the marking contour from the background on the workpiece to be used for the detection of the marking contour.

Another solution according to the invention consists in that the filter comprises two filter regions which transmit different wavelength ranges and in that beam paths extending over the two filter regions, which transmit different wavelength ranges, converge at a common observation point on the workpiece, to which end optics focused onto the common observation point on the workpiece expediently lies between the sensor unit and the filter.

Such optics may be formed by a single lens arrangement, in particular a converging lens.

In this solution as well, the filter may have different coatings, or regions with and without a coating, for different wavelength ranges.

Further details of the invention may be found in the claims, the description and the drawings, in which:

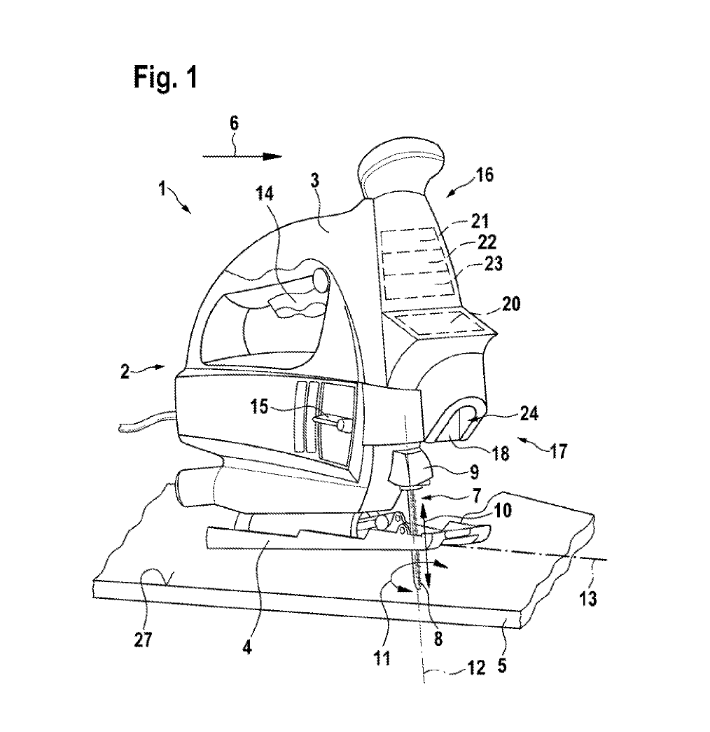

FIG. 1 shows a jigsaw as an example of a machine tool system equipped with a detection device for a marking contour on the workpiece,

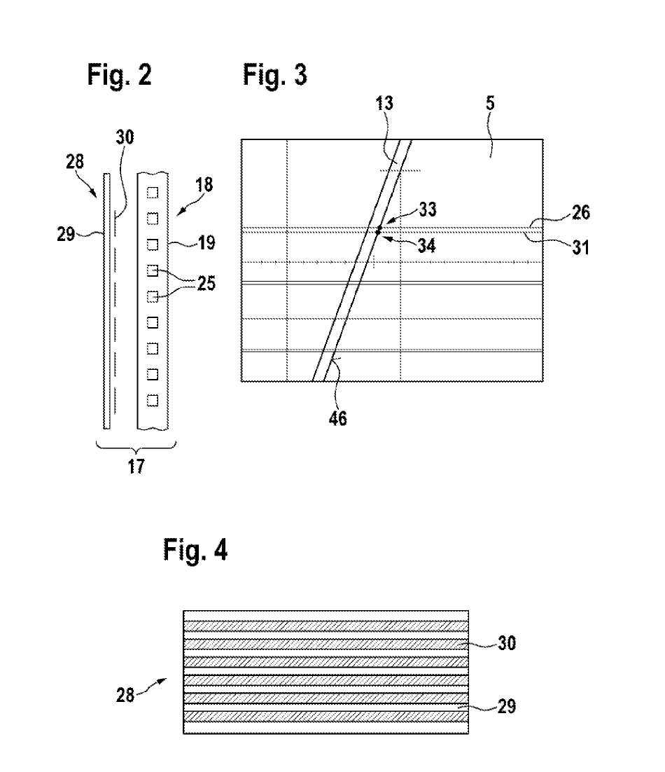

FIG. 2 shows a detection device in a highly schematic detailed representation, in the form of a line sensor with a line filter arranged in front at the interface with the workpiece (not represented),

FIG. 3 shows a marking in plan view on the surface of the workpiece, in the form of a working line with, extending transversely thereto, search lines which originate from detection elements of the line filter,

FIG. 4 schematically shows a strip filter in plan view, having filter strips formed by coating, and

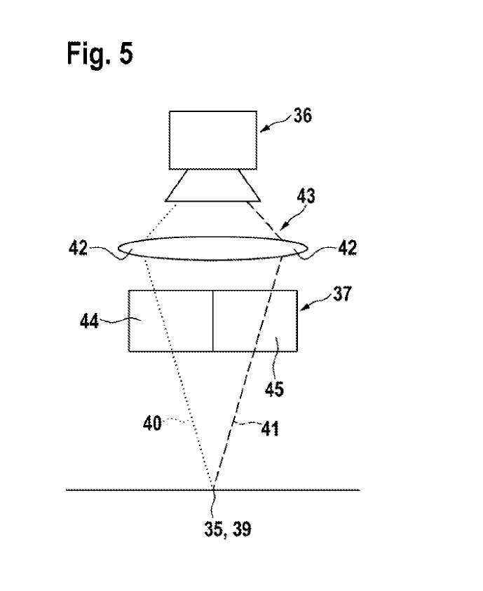

FIG. 5 shows another configuration of the detection device, wherein a common observation point on the workpiece is provided by the sensor unit of a camera with the interposition of a filter having filter regions which transmit different wavelength ranges.

FIG. 1 schematically represents a machine tool system having a jigsaw 2 as an example of a machine tool 1. The jigsaw 2 has a housing 3, which is displaceably supported on the surface 27 of a workpiece 5 by means of a baseplate 4. As its working tool 7, the jigsaw has a saw blade 8 for which a working plane is defined by its shape. The saw blade 8 is held in a tool chuck 9 and driven movably in strokes in the direction of the arrow 10. In the representation, the stroke axis of the saw blade 8 coincides with a rotation axis 12 about which, referring to the exemplary embodiment represented, the saw blade 8 can be rotated as represented by the arrow 11. The respective sawing direction, as a working direction, is defined by the rotational position of the saw blade 8. The working direction indicated by the arrow 6 corresponds to the straight working direction of the jigsaw, which is contained in the working plane of the saw blade 8 in its neutral central position, i.e. with an unrotated saw blade 8.

By the rotatability of the saw blade 8 about the rotation axis 12 according to the arrow 11, the jigsaw 2 can be operated as a so-called “scrolling jigsaw”, in which the jigsaw 2 operates aligned with a working line 13 according to the rotational position of the saw blade 8, so that with corresponding detection of the working line 13 by the machine the jigsaw 2 can be operated semiautonomously, or even autonomously, since the guiding work required of the user is at least substantially restricted to compensating for the reaction forces resulting from the working operation and to applying the forward displacement force for the jigsaw 2.

The jigsaw, if it is capable of operation in further operating modes, can be set to these operating modes by means of a switch device 15. The jigsaw 2 is switched on and off by means of a switch arrangement 14 provided in the handle region of the housing 2.

At least semiautonomous and autonomous working operation require a detection device 17 which, represented in the front region 16 of the jigsaw 2 in FIG. 1 and provided for detecting the working line 13 defined on the workpiece, which is represented as a marking, is arranged and aligned with the latter.

The detection device 17 comprises a sensor unit 18, likewise only indicated in FIG. 1, and expediently also an illumination arrangement 24 aligned with the working region on the workpiece and the working line 13 extending through the latter.

The computation unit 21 is used for processing the situation detected by means of the detection device 17 and the signals derived therefrom. The alignment of the saw blade 8 with the working line 13 which it is to follow is carried out by means of a control unit 22 and a subordinate adjustment device 23. FIG. 1 furthermore illustrates a display 20 on which, inter alia, the user can be provided with working safety instructions which are obtained from the observation of the working region of the workpiece for the saw blade 8 and/or which result from user-relevant information obtained in another way.

As can already be seen from the representation according to FIG. 1, accurate detection of the working line 13 defined as a marking on the workpiece is not always straightforward because of the technical working constraints such as dirt, dust and the like. Added to this, there is often not a unique contrast of the marking or markings forming the working line 13 with the appearance of the workpiece surface 27, not least depending on the appearance of the surface 27 as well, for example in the case of unevenly patterned surfaces 27 which are speckled or configured optically unevenly in another way.

With a view to this, the detection device 17 in the solution according to the invention is formed so that the marking contour 46 defined by the working line 13 is observed simultaneously in different wavelength ranges by means of the sensor unit 18, which will be explained in a first exemplary embodiment with the aid of FIGS. 2 to 4 and in a second exemplary embodiment with the aid of FIG. 5, partly with reference to the explanations above and the references used in FIG. 1.

Thus, FIG. 2 symbolically shows a structure of a detection device 17 which can be used in the scope of the invention, comprising a sensor unit 18, formed by a line sensor 19, the line sensor 19 having a number of light-sensitive detector elements 25, in particular light-sensitive detector elements 25, which are arranged in a row, are aligned with the marking provided on the surface of the workpiece 5 and acting as a working line 13, and scan the workpiece 5 on the surface in search lines 26, as illustrated in FIG. 3, the detection device 17 being used as a line sensor 19 in the embodiment as a camera.

Placed in front of the camera, or the sensor unit 18, there is a filter 28 which has separate filter regions 29, 30 for different wavelength ranges, which lie linearly next to one another and correspond in their function to a polarization filter or a bandpass filter. The filter regions 29, 30, which transmit or block different wavelength ranges, provide search lines lying close together and extending mutually parallel on the surface of the workpiece 5, of which those coming from detector elements 25 with uncoated filter regions 29 placed in front of them form for example the search lines 26, i.e. quasi standard search lines, while the search lines imaged through the coated filter regions 30, which are denoted by 31, extend close to the search lines 26; in a manner corresponding to the spacing of the search lines 26 coming from the detector elements 25, which lies in the micrometer range, the distance between the filter regions 28 and 30 is also of a corresponding order of magnitude.

In the procedure according to FIGS. 2 to 4 with observation of a marking contour region at very narrowly separated observation points 33, 34 with different wavelength ranges, and optionally subsequent combination of the data, sufficiently accurate indications of the contour 46 of the marking line which is tracked as a working line 13 can be obtained even under unfavorable conditions, this already being achievable with a few search lines 26, 31. Yet since there are many more lines when using a camera as the line sensor, and in general information obtained by means of these does not in fact need to be utilized, in the event of correspondingly unclear marking contours 46 these further lines may be employed without thereby entailing further outlay for the structure of the detection device 17.

In the configuration according to FIG. 5, points of the predetermined contour of the marking which lie close together are not detected as observation points as in the configuration according to FIGS. 2 to 4, but instead there is a common observation point 35 on the workpiece, which is detected starting from the sensor unit of a camera 36 via a filter 37 and lies at the focus 39 as the point of intersection of beam paths 40, 41 which, coming from the camera 36, pass through the edge regions 42 of optics preferably formed as a converging lens 43, and through the regions 44, 45 of the filter 37 which transmit different wavelength ranges. At the observation point 35, the marking contour is therefore observed over different wavelength ranges, so that the detection spectrum for the marking contour lying at the observation point is significantly extended, and detection of the working line 13 and tracking thereof during working operation can also be ensured even under unfavorable conditions.

1. A machine tool system, comprising:
a sensor unit configured to detect a marking contour provided on a surface of the workpiece,
wherein the sensor unit is configured to observe the marking contour simultaneously in different wavelength ranges.

2. The machine tool system as claimed in claim 1, wherein:
the sensor unit includes a filter which has separate filter regions for different wavelength ranges, and
the sensor unit is configured to observe the marking contour through the filter.

3. The machine tool system as claimed in claim 1, wherein:
the sensor unit includes a line sensor,
the line sensor is configured to observe the marking contour at mutually adjacent observation points, and
the line sensor includes strip-shaped filters located in front on the marking side.

4. The machine tool system as claimed in claim 2, wherein the filter comprises strip-shaped filter regions configured to transmit different wavelength ranges.

5. The machine tool system as claimed in claim 3, wherein the strip-shaped filters are coated differently, or coated and uncoated, the strip-shaped filters and search lines of the line sensor having the same extent.

6. The machine tool system as claimed in claim 1, wherein the filter is configured to observe the marking contour with at least two wavelength ranges and those lines on which there are the greatest contrast differences of the marking contour from the background on the workpiece are respectively used for the detection of the marking contour.

7. The machine tool system as claimed in claim 2, wherein the filter comprises two filter regions configured to transmit different wavelength ranges and beam paths extending over these filter regions that converge at a common observation point on the workpiece.

8. The machine tool system as claimed in claim 7, further comprising a lens arrangement, focused onto the observation point and located between the sensor unit and the filter.

9. The machine tool system as claimed in claim 7, wherein the filter comprises only two filter regions configured to transmit different wavelength ranges.

10. The machine tool system as claimed in claim 9, wherein the only two filter regions are differently coated, or coated and uncoated.

11. The machine tool system as claimed in claim 8, wherein the lens arrangement includes a converging lens.
